(19) United States
(12) Patent Application Publication
(10) Pub. No.: US 2011/0310621 A1
(43) Pub. Date: Dec. 22, 2011

(54) AUTOMATICALLY COMMISSIONING OF DEVICES OF A NETWORKED CONTROL SYSTEM

(75) Inventors: Petrus Desiderius Victor Van Der Stok, Helmond (NL); Lorenzo Feri, Eindhoven (NL); Willem Franke Pasveer, Dordrecht (NL); Tim Corneel Wilhelmus Schenk, Eindhoven (NL)

(73) Assignee: KONINKLIJKE PHILIPS ELECTRONICS N.V., EINDHOVEN (NL)

(21) Appl. No.: 13/203,255

(22) PCT Filed: Feb. 19, 2010
(86) PCT No.: PCT/IB2010/050736

§ 371 Date: Aug. 25, 2011

(30) Foreign Application Priority Data
Feb. 26, 2009 (EP) 09153736.5

(51) Int. Cl. G06F 15/173; F21V 5/04

(52) U.S. Cl. 362/311.12; 709/224; 362/311.01

(57) ABSTRACT

The invention relates to automatically commissioning of devices of a networked control system, particularly to automatically commissioning (auto-commissioning) of light sources of a lighting system, where a control of light sources on an individual and local basis is required. A basic idea of the invention is to route commissioning messages through a grid, particularly an approximately rectangular grid of devices in that each device is able to receive commissioning messages from and to transmit commissioning messages to directly neighbored devices in the grid via light. An embodiment of the invention relates to a method for automatically commissioning of devices (10, 12, 14, 16, 18) of a networked control system, which comprises several devices arranged in a grid (20), wherein each device is adapted for routing messages, which were received from directly neighbored devices in the grid, to directly neighbored devices in the grid via light, wherein the commissioning comprises the acts of
transmitting a commissioning message (S10), which comprises a hops counter, by a first device (10) to a second device (12), which is neighbored to the first device in a predetermined direction (22) in the grid,
receiving the commissioning message (S12) from the first device by the second device,
updating the hops counter (S14) by the second device and a location counter of the second device and
transmitting the commissioning message (S16) with the updated hops counter to one or more third devices.

### FIELD OF THE INVENTION

The invention relates to automatically commissioning of devices of a networked control system, particularly to automatically commissioning of light sources of a lighting system, where a control of light sources on an individual and local basis is required.

### BACKGROUND OF THE INVENTION

Networked control systems are a ubiquitous trend in commercial, industrial and institutional business markets and also in consumer markets. An example of a networked control system is a complex lighting system with dozens of light sources. Particularly, in professional environments it becomes more and more interesting to control lights on an individual and local basis. Examples of such environments are green houses, factory buildings, sport halls, office buildings and outdoor (matrix) light displays. Messages to control individual lights can be centrally generated, e.g. for the outdoor (matrix) light display, but might also be based on local sensor findings, e.g. for greenhouses/offices.

Individual control of light sources is usually done by attaching a communication node to each light source that needs to be controlled, e.g. ballast. Each node has a unique network address, so that messages can be addressed to it. This principle can be extended to other home automation equipment. The control commands are sent to a node/group of nodes at a given location within the building/environment, to regulate the lighting at its location. To this end, the network addresses of the nodes need to be mapped to their physical locations in order to know which lamps are where and to know which lamps are close. Usually this is done by hand, where an installer walks around all control points and records the network address, and the location, of a node at a given location typically by using dedicated software. This process, often referred to as commissioning, is a cumbersome and error prone operation.

WO2007/102114A1 relates to grouping of wireless communication nodes in a wireless communication network, which are configured to control the operation of luminaries in a lighting array. A computer algorithm for grouping a derived spatial arrangement of wireless communication nodes is provided. The position of each node in the communication network corresponds to the position of a particular luminary in the lighting array. The algorithm divides the arrangement of nodes into a plurality of spatial groups, each of which is defined by a line which joins the group's member nodes together. The groups are ranked according to their statistical attributes and a number of groups are selected as control groups, such that the member nodes, and hence luminaries, of each control group may be controlled by a single switch or sensor.

### SUMMARY OF THE INVENTION

It is an object of the invention to provide a system, method, and devices for automatically commissioning of devices of a networked control system.

The object is solved by the subject matter of the independent claims. Further embodiments are shown by the dependent claims.

A basic idea of the invention is to route commissioning messages through a grid, particularly an approximately rectangular grid of devices in that each device is able to receive commissioning messages from and to transmit commissioning messages to directly neighbored devices in the grid via light, wherein a commissioning message comprises a hops counter, which may be updated on each hop of the message through the grid, and each device has a location counter, which may be updated in accordance with the hops counter of a commissioning message. If the networked control system is a lighting system with luminaries arranged in a rectangular grid, such as in a hall or a green house, the main light created by the luminaries may be used for transmitting and receiving the commissioning messages. Thus, no extra means such as RF (Radio frequency) receiver and transmitter for routing commissioning messages are required. Instead, coded light technology may be applied for the routing of messages through the grid. The invention may be enabled with a minimum of technical overhead by exploiting the regular arrangement of devices in a grid. Finally, commissioning can be performed in a fully automatic manner not requiring the assistance of any person.

An embodiment of the invention provides a method for automatically commissioning of devices of a networked control system, which comprises several devices arranged in a grid, particularly an approximately rectangular grid, wherein each device is adapted for routing messages, which were received from directly neighbored devices in the grid, to directly neighbored devices in the grid via light, wherein the commissioning comprises the acts of
transmitting a commissioning message, which comprises a hops counter, by a first device to a second device, which is neighbored to the first device in a predetermined direction in the grid,
receiving the commissioning message from the first device by the second device,
updating the hops counter by the second device and a location counter of the second device and
transmitting the commissioning message with the updated hops counter to one or more third devices.

Each device in the grid has at least two, typically four direct neighbors, except devices located at the boundaries or in the corners of the grid, which have merely one, three or two directly neighbored devices, respectively. Thus, a grid of devices comprises any arrangement of device with at least one predetermined direction of arrangement of devices, such an array of devices, a two-dimensional for example matrix-like arrangement of devices or even a three-dimensional for example cubicle-like arrangement of devices. In the grid, messages can only be routed from device to device in predetermined directions. In a rectangular grid, the predetermined directions are orthogonal directions, preferably vertical and horizontal directions. Each device may be located in a rectangular grid by a tuple of coordinates, determining the position in the grid, for example [0, 0] may determine the position in the lower left corner of the grid. A location counter of a device may comprise the tuple of coordinates, typically the row and column of the device in the grid. A commissioning message is routed from the device, which initiates the message, to an end device in the grid, typically a device at the boundary of the grid. For example, when a commissioning message is initiated by a device in the left lower corner of the grid, with a predetermined vertical or up direction in the grid, the message is routed through the entire column over all rows in the grid and usually ends on the device in the upper left corner of the grid. Similarly, a commissioning message, which is initiated by the device in the lower left corner of the grid with a predetermined horizontal or right direction, is routed through the entire row over all columns in the grid until it usually ends on the device in the lower right corner of the grid.

The act of updating of the hops counter by the second device may comprise incrementing the hops counter by one and the act of updating the location counter of the second device may comprise setting the location counter to the maximum of the updated hops counter and the actual location counter. Thus, the location of devices in the grid may be determined with a commissioning message, which is routed from device to device through the grid and updated by each receiving device. Thus, each device may simply determine with the hops counter of the commissioning message its coordinate in the predetermined direction.

Furthermore, the act of updating of the hops counter by the second device may comprise comparing the hops counter of the received commissioning message with the actual location counter of the second device and incrementing the hops counter by one only if the comparing results in that the hops counter is larger than or equal to the actual location counter of the second device. This allows avoiding problems with faulty devices, which usually do not route and update received commissioning messages. A faulty device may cause the start and stop of commissioning messages, which should only start and stop at end devices in the grid. Commissioning messages being started in the neighborhood of faulty devices may however cause commissioning messages with incorrect hops counters. With the comparison of the hops counter of a received commissioning message with the actual location counter, an incorrect update of the hops counter and the location counter of a device may thus be avoided.

The act of updating of the hops counter by the second device may further comprise rejecting the received commissioning message if the comparison results in that the hops counter is smaller than the actual location counter of the second device. This allows keeping the number of commissioning messages small and the data traffic due to the routing of commissioning messages low, because unnecessary routing of commissioning messages through the grid is avoided.

The transmitting of the commissioning message with the updated hops counter to one or more third devices may comprise transmitting the commissioning message with the updated hops counter to a third device, which is neighbored to the second device in the predetermined direction in the grid, or to third devices, which are neighbored to the second device in the predetermined direction in the grid and in two further different directions, each being different from the predetermined direction. The latter method allows routing of commissioning messages through the grid not only in one predetermined direction, for example in the up direction, but also in other directions, for example in the left and right direction. Thus, faulty devices may be circumvented, and a loss of a commissioning message due to a faulty node may be avoided. Furthermore, the location counters of devices neighbored to a faulty device may be checked whether they are correct, and eventually updated in order to be correct.

A third device, which is neighbored to the second device in a direction different from the predetermined direction, may transmit a commissioning message in the predetermined direction in the grid. Thus, a commissioning message is routed around a faulty device, but does not deviate from the predetermined direction.

A third device, which is neighbored to the second device in a direction different from the predetermined direction, may also transmit a commissioning message in the predetermined direction in the grid and in the two further different directions, each being different from the predetermined direction. Thus, a commissioning message may be routed on not only in the predetermined direction, but also in the other different directions. This allows routing of a commissioning message on a flexible way though the grid and to improve the commissioning since also clusters of faulty devices may be circumvented.

Several commissioning message may be routed in parallel through the grid in one or more predetermined directions. Thus, the total commissioning time is essentially determined by passing a commissioning message over all rows of the grid followed by a commissioning message over all columns. The redundancy of commissioning messages may die out quickly, if a test on the hops counters and location counters is performed and commissioning messages may be rejected.

An embodiment of the invention provides a computer program enabling a processor to carry out the method according to the invention and as described above.

According to a further embodiment of the invention, a record carrier storing a computer program according to the invention may be provided, for example a CD-ROM, a DVD, a memory card, a diskette, internet memory device or a similar data carrier suitable to store the computer program for optical or electronic access.

A further embodiment of the invention provides a computer programmed to perform a method according to the invention such as a PC (Personal Computer).

A further embodiment of the invention provides a system for automatically commissioning of devices of a networked control system, which comprises several devices arranged in a grid, particularly an approximately rectangular grid, wherein each device is adapted for routing messages, which were received from directly neighbored devices in the grid, to directly neighbored devices in the grid via light, wherein the system is configured to commission the devices by performing the acts of
transmitting a commissioning message, which comprises a hops counter, by a first device to a second device, which is neighbored to the first device in a predetermined direction in the grid,
receiving the commissioning message from the first device by the second device,
updating the hops counter by the second device and a location counter of the second device and
transmitting the commissioning message with the updated hops counter to one or more third devices.

The system may be further adapted to perform a method of the invention and as described above.

Furthermore, an embodiment of the invention relates to a device being adapted for application in a system of the invention and as described before, particularly a luminary, and being further adapted to communicate directional light messages.

The device may comprise at least one of the following features:
the device is a luminary and being adapted in that the light of the main light source of the luminary is used for communication by means of directional light messages;
the device comprises collimators and/or lenses being applied to a light source used for communicating directional light messages and/or to a light sensor used for receiving directional light messages from other devices;
the directional light messages are invisible to the human eye;
the devices is adapted to communicate directional light messages in four different directions;
the devices is adapted to communicate directional light messages in four different directions, wherein the different directions are separated by an angle of 90° degree.

These and other aspects of the invention will be apparent from and elucidated with reference to the embodiments described hereinafter.

The invention will be described in more detail hereinafter with reference to exemplary embodiments. However, the invention is not limited to these exemplary embodiments

### BRIEF DESCRIPTION OF THE DRAWINGS

FIG. 1 shows an embodiment of a lighting system with luminaries arranged in a rectangular grid such as in a green house or sports hall;

FIG. 2 shows an embodiment of luminaries according to the invention;

FIGS. 3 and 4 show different examples of modulation schemes for transmitting data with light between luminaries;

FIG. 5 shows a flow chart of an embodiment of the method for automatically commissioning of devices of a networked control system such as a lighting system according to the invention;

FIG. 6 shows a flow chart of an embodiment of step S14 of the flow chart of FIG. 5 according to the invention;

FIG. 7 shows a flow chart of another embodiment of step S14 of the flow chart of FIG. 5 according to the invention;

FIG. 8 shows an embodiment of a lighting system with luminaries arranged in a rectangular grid with the addresses of the luminaries in the grid after performing a first algorithm for auto-commissioning the luminaries in the lighting system according to the invention;

FIG. 9 shows the lighting system of FIG. 8 with isolated faulty luminaries and the addresses of the luminaries after performing the first algorithm for auto-commissioning the luminaries according to the invention;

FIG. 10 shows the lighting system of FIG. 8 with isolated faulty luminaries and the addresses of the luminaries after performing a second algorithm for auto-commissioning the luminaries according to the invention;

FIG. 11 shows the lighting system of FIG. 8 with several faulty luminaries in a row and the addresses of the luminaries after performing the second algorithm for auto-commissioning the luminaries according to the invention;

FIGS. 12 and 13 show the lighting system of FIG. 8 with several faulty luminaries and the propagation of a commissioning message through the grid according to the second algorithm for auto-commissioning the luminaries according to the invention;

FIG. 14 shows the lighting system of FIG. 8 with several faulty luminaries in a row and the route of a commissioning message starting at the luminary with address [2, 6];

FIG. 15 shows the lighting system of FIG. 8 with several faulty luminaries in a row and an example of a multicast routing algorithm for commissioning messages according to the invention; and

FIG. 16 shows the lighting system of FIG. 8 with several faulty luminaries in a row and an example of a broadcast routing algorithm for commissioning messages according to the invention.

### DETAILED DESCRIPTION OF EMBODIMENTS

In the following, functionally similar or identical elements may have the same reference numerals. Even if embodiments of the invention, which are described in the following, relate to lighting systems, the invention is generally applicable to networked control systems, which comprise several devices to be commissioned.

In professional environments it becomes more and more interesting to control lights on an individual and local basis. Examples of such environments are green houses, factory buildings, sport halls, office buildings and outdoor (matrix) light displays. Instead of switching on or off all luminaries, it is preferred to control single luminaries or groups of luminaries in order to locally create light effects in certain areas, for example in order to illuminate certain areas in an office building or to create light for only some plants in a certain place in a green house. Also, often it is required to individually control luminaries of a lighting system with for example a central controller of the lighting system, which is only possible if all luminaries of the lighting system are commissioned, i.e. are recorded in a database of the computer with their at least relative location in the lighting installation so that an operator can decide which luminary to activate. Complex lighting systems are usually organized as a networked control system, which means that the devices of the system such as luminaries or groups of luminaries are part of a network and may be individually addressed and controlled for example by control messages. The control messages can be centrally generated, e.g. by a central controller such as a computer provided for controlling luminaries of for example an outdoor (matrix) light display, but might also be based on local sensor findings, e.g. in a lighting system for greenhouses or offices.

Typically, individual control of luminaries in such networked lighting systems is done by attaching a communication node to each luminary that needs to be controlled, e.g. ballast. The node may be integrated in the luminary or attached as separate device. The addressable node forms a device of a networked control system. A node may control a single luminary or several luminaries. In a networked lighting system, each of the nodes has a unique network address, so that messages from a central controller can be directly addressed and routed to it. A message means any control command for controlling devices attached to an addressed node, for example “dimming of all luminaries connected to node with address xyz” or “activating the luminary at node with address xyz”. The messages or control commands are sent to a node or a group of nodes at a given location within a building or an environment, to regulate the lighting at its location. In order to be able to control the luminaries at locations, the network addresses of the nodes need to be mapped to their physical locations. Without the knowledge of which lamps are where and which lamps are close to a certain location, an individual or local control is not possible. The mapping of the network addresses of nodes or devices of the networked lighting system is herein referred to as commissioning. Since commissioning is a cumbersome and error prone process, typically performed manually, an automatic commissioning (auto-commissioning) process is desirable in order to avoid not only any errors during the commissioning, but also to save time and costs.

In professional environments, the luminaries of a lighting system are often organized in rectangular grids. The position of the luminaries, and consequently that of the nodes, on the grid effectively represents the physical location of the node and can be used for control messaging. In this way there is an inherent mapping between the physical location of a luminary and it control address. The location, expressed as grid point, can easily be determined by connecting the nodes with wires along the grid paths. A connection between luminaries in a grid may be made either wired or wireless, for example via RF (Radio Frequency) or IR (Infrared) or visible light. When luminaries in the grid solution are connected by wires, most luminaries require 4 lines to be connected to the neighbored luminaries, instead of for example only one wire in case of a bus structure such as the most applied standard DALI, or DMX, which is often used for outdoor matrix light displays. This complex wiring in the grid solution clearly increases the chance that an installer makes an error in the connection of the control wires. Thus, the invention proposes to reuse the light of the light source(s) in each luminary to perform an auto commissioning. In one embodiment this light is also used to propagate the control or commissioning messages.

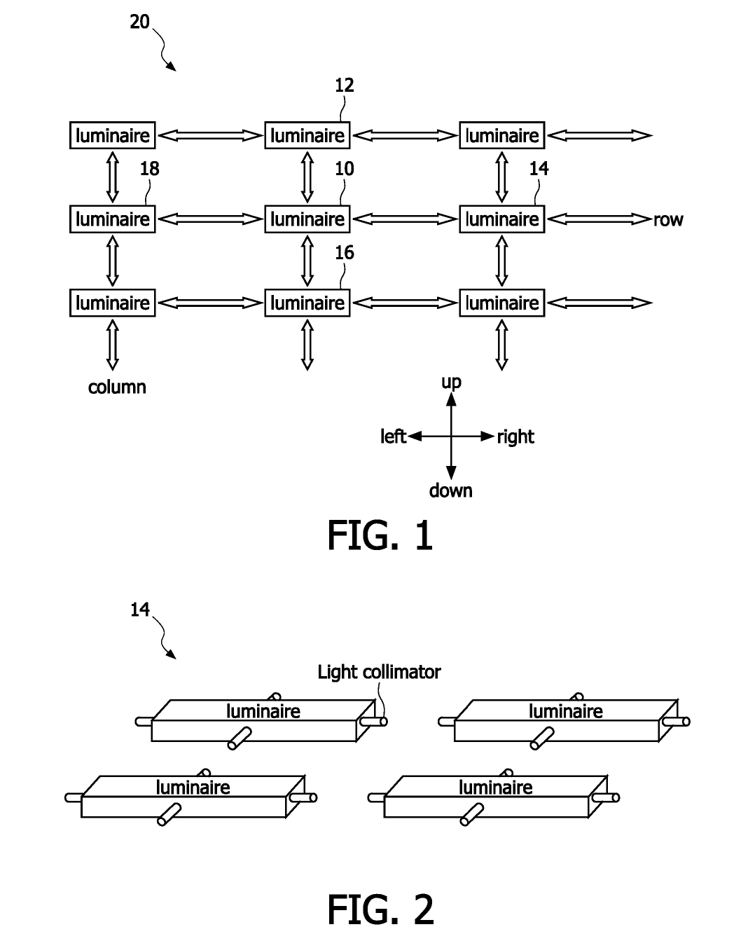

FIG. 1 shows an example of a lighting system 20 comprising luminaries, which are arranged in a rectangular grid. FIG. 1 shows also how the luminaries in the rectangular grid, depicted by rectangular boxes, are interconnected by light cones represented by the double arrows. Each luminary in the grid is connected to its directly neighbored luminaries, for example luminary 10 is connected to luminary 12 in the same column in the up direction, to luminary 16 in the same column in the down direction, to luminary 14 in the same row in the right direction, and to luminary 18 in the same row in the left direction. A connection means a communication connection, over which a luminary or node may transmit messages or commands to another directly neighbored luminary or node. A message sent from a first luminary to a second luminary may be forwarded in a predetermined direction to a third luminary in the grid and so on until the message is received by a luminary with no direct neighbor in the predetermined direction. The message may be updated by each receiving luminary under certain circumstances, thus allowing determining the position of a luminary in the grid. For example, by sending messages to the upper or right neighbor in the grid, the physical locations of the luminaries may be established in an automatic fashion, as will be described below in detail. Messages or commands are sent to the luminaries or nodes by expressing their location in for example a destination specifier, contained in a message or command. A routing algorithm calculates how messages should be forwarded in the grid, as will be also specified in more detail below.

As mentioned above, the luminaries communicate via light, particularly the light created by the main light source of each luminary. In order to create light cones, light collimators may be used, as exemplified in FIG. 2. Alternatively also lenses can be applied to create the directional light. The light interconnections between luminaries may be realized with coded light, a technology for data transmission via visible light communication. The lamp in a luminary emits a data stream that, depending on the light source type, ranges from a few kbps to a few hundreds of kbps. At the neighbor luminary the light is received in a cone with a narrow opening angle, for example of 10°. In an embodiment, the light transmitted by a luminary may be non-directional, so that it can be received by all neighboring luminaries. The location process, necessary for the auto commissioning, may be only based on the directionality of the receivers for the light communication. In an alternative embodiment also the emitted light may be directional. In this embodiment it is necessary that different data are transmitted to the 4 different directions in the grid. This can be achieved by collimators feeding the light from the main light source. To be able to send independent messages to the different sides of the luminary, the tubes can be equipped with a shutter which is only open ¼ of time. These shutters should be synchronized with the data transmitted by the main lamp in the luminary, i.e. the shutter should be open when data should be emitted to that side. The receiver can be placed in the same tube to achieve directional reception.

Alternatively the light interconnection may realized by means of additional light sources, added to the luminaries for the data communication. For example, this extra light source can be an IR LED (Infrared Light Emitting Diode). This has the advantage that this solution can also be used when the main light source is fully switched off. Moreover, the different light sources can be modulated independently from the main light source, not requiring shutters as in the solution above.

Coded Light technology as applicable for the present invention may apply the modulation of light from visible light sources. This allows embedding data in the light itself. The modulation can be designed such that it is invisible to the human eye. Such feature is particularly important for consumer applications since no light disturbance is tolerated. However, for professional applications like commissioning, data modulations that produce a certain level visible flickering might also be acceptable. Different types of light sources may employ different modulation schemes. As an example, different modulation schemes may be applied for solid state light (SSL) sources and fluorescent light sources. The modulation of other light sources, such as fluorescent, HID and Halogen, is also possible.

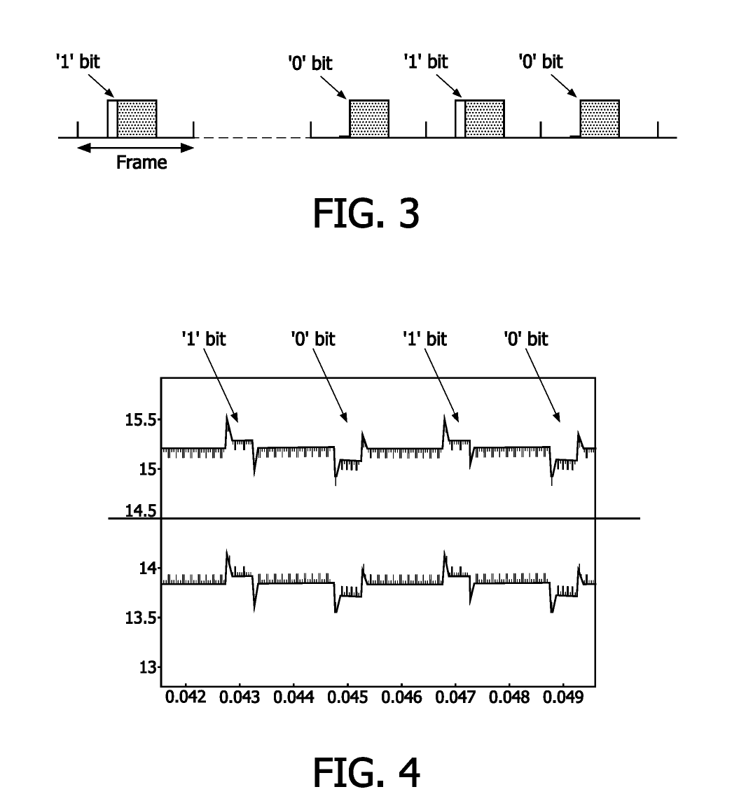

FIG. 3 shows an embodiment of a light modulation scheme for SSL sources. The conventional way to drive an SSL source is to use a pulsed current, constituted by a train of rectangular pulses. By adjusting the length of the pulses, and therefore the duty cycle of the current, the light level can be varied. Data modulation is possible by creating small variations of the pulse lengths. When short and frequent enough, these variations are imperceptible to human eyes.

FIG. 4 shows an example of light modulation scheme for fluorescent light sources. The conventional way to drive a fluorescent light source is to use a high frequency alternating current, which is injected in the lamp via an half bridge. The half bridge behaves as a low pass filter, so varying the frequency of the current has an effect on the electrical power delivered to the lamp and therefore on the light level. Data modulation is possible by creating small variations of the light level. When small and frequent enough, these variations are imperceptible to human eyes.

As already mentioned above, also extra light sources can be added to allow the interconnection among luminaries. For example, IR LEDs may be used.

In the following, the commissioning solution according to the present invention is briefly compared to DALI. A DALI command passes via an I/O control unit to the luminary via a bus system. This hierarchical approach introduces an extra control unit that is not needed in the communication solution shown in the wired grid of FIG. 1. The DALI addressing scheme has a limited amount of addresses per installation (16 groups of 64 nodes totals 1024), while the addressing in the wired grid is more flexible and is foreseen to cover at least hundred rows and hundred columns yielding a minimum of 10000. Furthermore, the DALI standard is not readily amenable to automatic commissioning. Instead, the wired grid according to the invention is specially developed for commissioning purposes on a grid. A special solution may be to add the grid connections to the DALI control. The grid connections may then do the commissioning while DALI infrastructure may be used to actually control the luminaries.

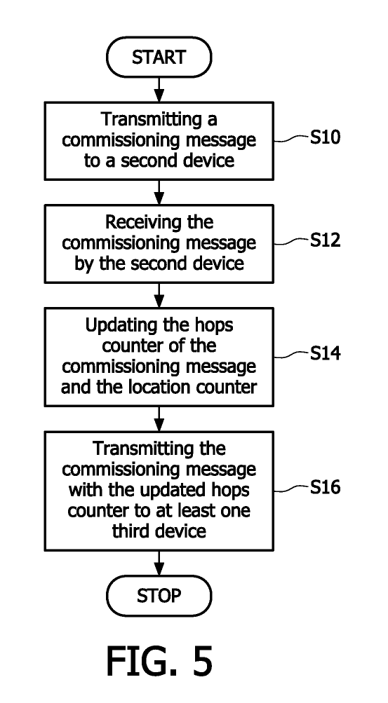

Next, a first embodiment of the method for automatically commissioning of devices in a rectangular grid of devices such as luminaries, as shown in FIG. 1, is explained with reference to FIG. 5, which shows a flow chart of an algorithm implementing the method. In a first step S10, a first device such as luminary 16 of the lighting system 20 of FIG. 1 transmits a commissioning message via coded light technology as described above to a second device such as luminary 10 of FIG. 1 in a predetermined direction such as the up direction in FIG. 1. The message is received by the second device or luminary 16 in step S12 and decoded in order to read the hops counter contained in the received message. Then in step S14, the hops counter is updated, for example incremented by one for one hop of the message from the first to second device in the grid, and a location counter, stored in the second device, is also updated, typically set to the incremented hops counter of the message. In the following step S16, the commissioning message with the updated hops counter is transmitted by the second device to at least one third device such as luminary 12 of FIG. 1. This process is continued until the last device in the predetermined direction is reached, i.e. the flow chart shown in FIG. 5 is typically a part of more complex method for commissioning all devices in the grid.

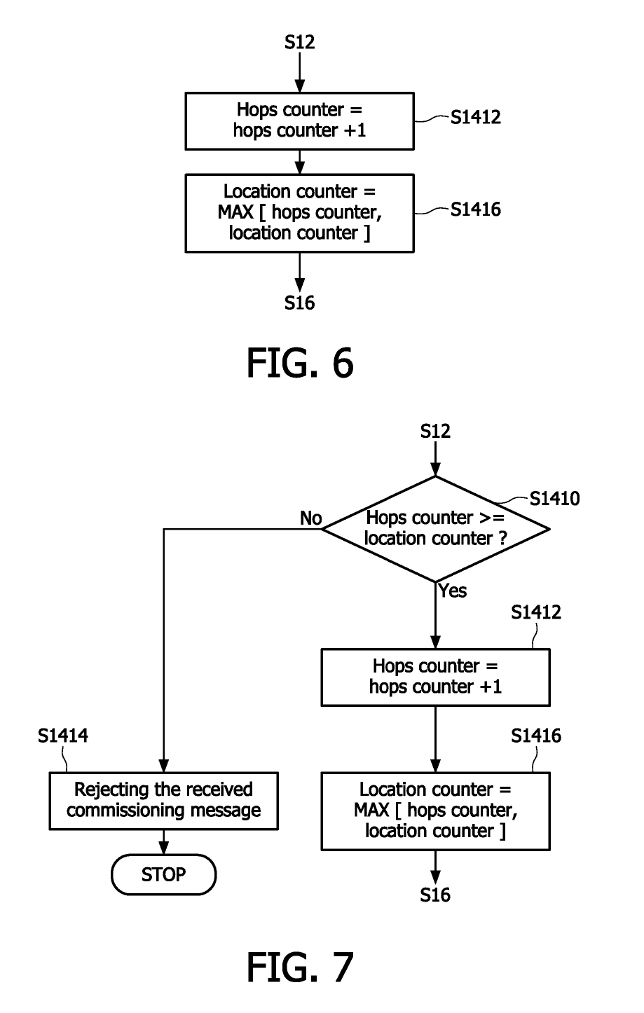

FIG. 6 shows in detail an embodiment of step S14 of FIG. 1: in step S1412, the hops counter of the commissioning message is incremented by one, and in the following step S1416 the location counter of the second device is set to the maximum of the actual hops counter and the location counter. For example, when luminary 16 of the lighting system shown in FIG. 1 transmits a commissioning message with a value 0 for the hops counter in the up direction as predetermined direction to the luminary 10 as second device, the luminary 10 increments the hops counter value 0 to 1 and set its location counter for its column location to 1, since its initial location counter for its column location is 0.

FIG. 7 shows another embodiment of step S14 of FIG. 1, which differs from the embodiment of FIG. 6 in that a received commissioning message may also be rejected, if the hops counter contained in the received commissioning message is not plausible, as it may occur when faulty nodes or devices exist in the grid of devices. Later, the case of faulty devices and its influence on the commissioning method according to the invention is discussed in more detail. The embodiment of FIG. 7 comprises a step S1410 for checking whether the hops counter of the received commissioning message is equal to or larger than the actual location counter of the receiving second device. If the hops counter is smaller, then the received commissioning message is rejected in step S1414, which means that the message is not updated and passed on the third device, thus significantly reducing the number of transmitted messages. This is for example the case, when the commissioning message has an incorrect hops counter due to faulty devices, or it is initiated by a device or node in the middle of the grid. However, if hops counter is equal to or larger than the actual location counter of the second device, the hops counter is incremented by one in step S1412, and the location counter of the second device is also updated by setting it to the maximum of the updated hops counter and the actual location counter in the following step S1416.

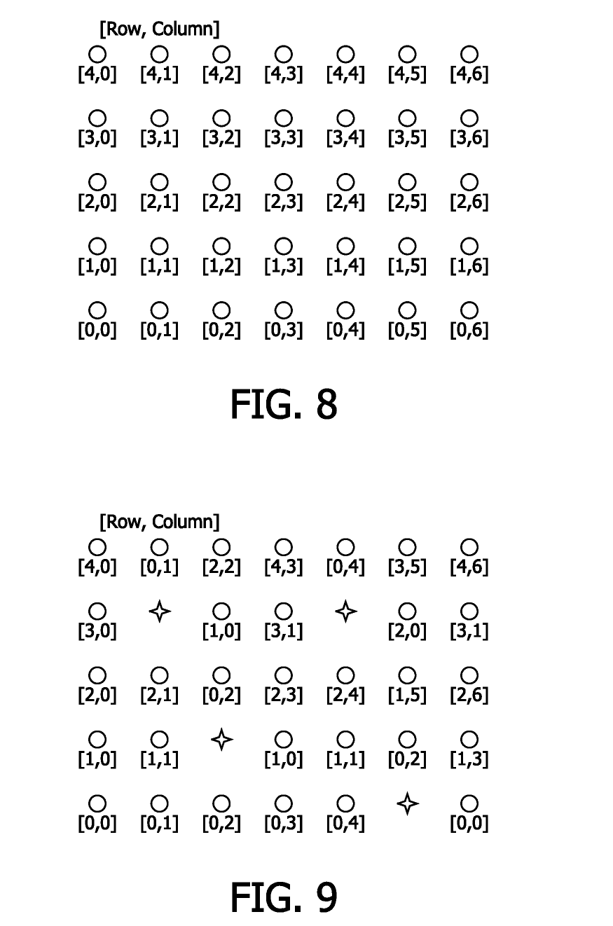

Next, several embodiments of commissioning algorithms according to the present invention are explained in more detail by means of a lighting system with luminaries arranged in a rectangular grid, as shown in FIG. 8.

As already explained above, commissioning algorithms serve to allocate a position expressed in column and row to each node in a grid. In the following, a node is a luminary, even if a node may also control several luminaries. The complexity of the algorithm depends on the fault hypothesis and the range of the light-bundle. An x-neighbor is a neighbor in the x-direction, with x in {up, down, left, right}. Isolated faulty node means that the node is faulty but all its neighbors are correct. The leading assumption is that all nodes are switched on before the algorithm is executed. At the end it is looked at the consequences of the order of switching on.

Algorithm 1:

The first algorithm 1 is the simplest one and corresponds to the method with the flow chart shown in FIG. 5. It is assumed that none of the nodes of the grid is faulty, i.e. each node is able to communicate commissioning messages to neighbored nodes. Each node has as a location counter a pair or tuple [column_counter, row_counter], which are initialized to (0, 0). The location counter determines after performing the commissioning algorithm the relative position of a node in the grid. A column-message and a row-message are distinguished as commissioning messages. According to the first algorithm 1, each node sends a row-message ms with the entry row_hops, initialized to 0, in the up direction, for example in FIG. 8 node or luminary [0, 0] sends a row-message ms to node [1, 0] in the predetermined up direction. The entry row_hops is part of a hops counter of the message. On reception of a row-message ms from the down direction by a node, the value of ms.row_hops is incremented with one and the value of row counter is set equal to MAX(ms.row_hops, row_counter). The message with the incremented value is sent on in the up direction until the last node in a column is reached. The same process is repeated to calculate the column_counter value. Each node sends a column-message ms with the entry column_hops, initialized to 0, in the right direction. Also, the entry column_hops is part of a hops counter of the message. On reception of a column-message ms from the left direction, the value of ms.column_hops is incremented with one and the value of column counter is set equal to MAX(ms.column_hops, column_counter). The end result of the commissioning process is shown in FIG. 8. Green dots represent nodes and the location counter, i.e. the [x,y] pair the calculated row, and column numbers. Now, the location counter of each node determines the relative position of the node in the grid, i.e. [0, 0] is the lower left corner of the rid and [4, 6] is the upper right corner.

In another situation, the range of a commissioning message is one hop, the grid now contains isolated faulty nodes, for example defect luminaries, and the algorithm works without a commissioning message loss. This case is more difficult compared to the situation described above, where no faulty nodes exist in the grid. When the column- and the row-part of the algorithm 1 are executed, then a commissioning message will start and stop not only at the end points of the grid but also at the faulty nodes. In FIG. 9, the result on labeling after performing algorithm 1 shows that from the faulty node onwards, the row numbering and column numbering starts from zero again. A faulty node is represented with a star. Thus, algorithm 1 works well in grids without faulty nodes, but does not deliver correct commissioning results if faulty nodes exist in the grid.

Algorithm 2:

Under the assumption that faulty nodes are isolated, i.e. they have no faulty one-hop neighbor nodes, the algorithm can be made to work with more messages. According to a second algorithm 2, each node sends a row-message ms with the entry row_hops, initialized to 0, in the up direction. On reception of a row-message ms from the down direction, the receiving nodes now checks whether ms.row_hops<row_counter; if this is the case, the received row-message is rejected by the receiving node. If ms.row_hops>=row_counter, the value of ms.row_hops is incremented with one and the value of row_counter is set equal to MAX(ms.row_hops, row_counter). This corresponds to the procedure as shown in FIG. 7 and as described above. The row-message ms with the incremented value is then sent on in the left, up and right direction, which differs from the first algorithm 1, which allows sending on a message only in the predetermined direction. On reception of a row-message ms from the left (right) direction, the value of ms.row_hops is compared with the value of row_counter. When ms.row_hops>row counter, row counter is set equal to ms.row_hops, and the message is sent on again in the predetermined direction, namely in the up direction with an incremented ms.row_hops. The same process is repeated to find the column_counter value. Each node sends a column-message with the entry column_hops, initialized to 0, in the right direction. On reception of a column-message, ms, from the left direction, the receiving node checks whether ms.column_hops<column_counter; if this is the case, the message is rejected. If ms.column_hops>=column_counter the value of ms.column_hops is incremented with one and the value of column_counter is set equal to MAX(ms.column_hops, column_counter). The message with the incremented value is sent on in the up, right, and down direction. On reception of a column-message, ms, from the up (down) direction, the value of ms.column_hops is compared with the value of column_counter. When ms.column_hops>column counter, column counter is set equal to ms.column_hops, and the message is sent on in the right direction with an incremented ms.column_hops.

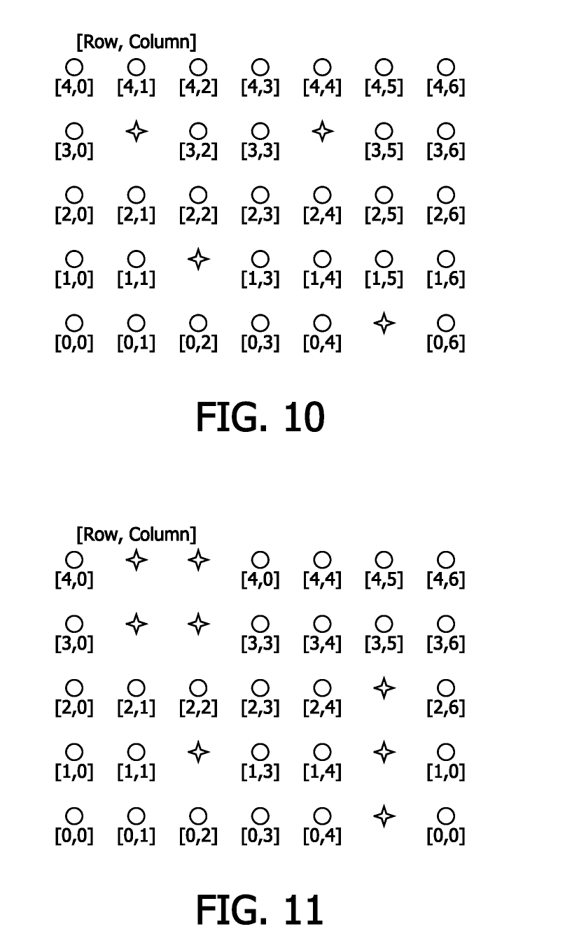

It can be seen from FIG. 10 that the second algorithm 2 works in most cases. For example the node [2, 2] was erroneously labeled with [0, 2] by the first algorithm 1, as shown in FIG. 9. In this improved second algorithm 2, the message arriving in [2, 3] from below will send the column value 2 to the left and the right and thus to [2, 2]. The node [2, 2] will overwrite the 0 with the 2 and is correctly labeled. The node sends this message on up, where the node [2, 3], previously falsely labeled [1, 0] will change the labeling to [1, 3]. And so forth. In the next stage also the row number will be corrected. When the hop value in a message is lower than the calculated values in the node, the message is rejected, to reduce traffic and delay. However, algorithm 2 fails to deliver correct commissioning results, when several nodes in a cluster are faulty, for example several neighbored nodes in a row, column or both. FIG. 11 shows the unwanted result of algorithm 2 when several nodes on a row are faulty. For example the node [4, 3] is wrongly labeled with [4, 0], because the row-message with the column number 3 arrives at node [3, 3] via node [2, 3] but is not passed on to node [4, 3]. Column number of node [4, 4] is updated from node [3, 4]. The same happens for nodes [0, 6] and [1, 6] which are not updated from node [2, 6].

Algorithm 3:

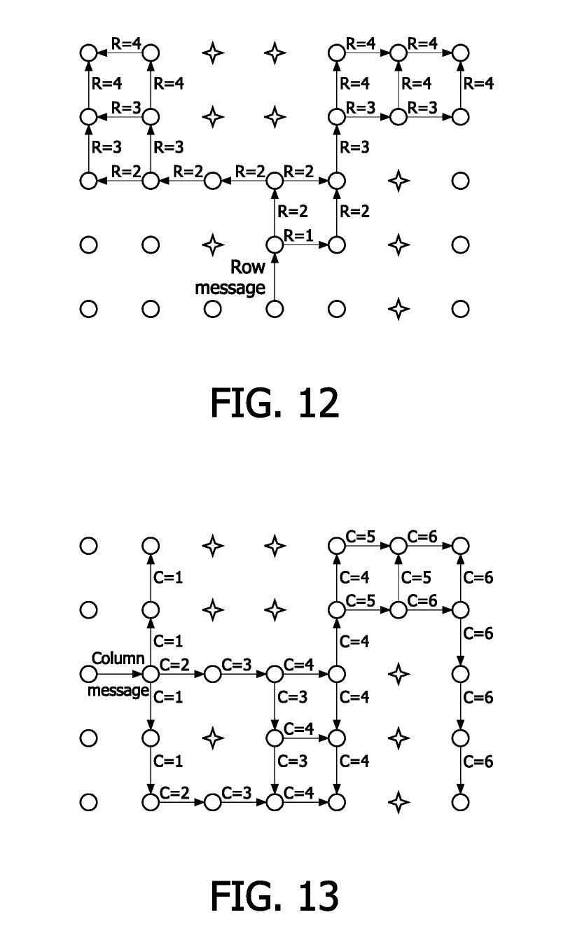

The second algorithm 2 can be made more robust by sending more messages in a row or column direction. This extension leads to a third algorithm 3, which also works with non-isolated faulty nodes. The flow of one column message and one row message is shown in FIGS. 12 and 13, respectively. The label R=x of C=x shows the column number or row number that is transported in the message. It can be seen that the origin of a single column-messages with C=1, or row message with R=1, percolates over almost the whole network. The tests in the nodes which reject messages with low values, as outlined in FIG. 7, prevent that the network is flooded with too many messages.

Algorithm 3 works as follows: Each node sends a row-message ms with the entry row_hops, initialized to 0, in the up direction. On reception of a row-message ms from the down direction and ms.row_hops<row_counter, the message is rejected. If ms.row_hops>=row_counter the value of ms.row_hops is incremented with one and the value of row_counter is set equal to MAX(ms.row_hops, row_counter). The message with the incremented value is sent on in the right, up and left direction, as it is done in the second algorithm 2. On reception of a row-message ms from the right (left) direction, the value of ms.row_hops is compared with the value of row_counter. When ms.row_hops>row counter, row counter is set equal to ms.row_hops, and the message is sent on in the right and left direction, and in the up direction with an incremented ms.column_hops. This differs from the second algorithm 2, which allows only sending on in the predetermined direction. The same process is repeated to find the column_counter value. Each node sends a column-message ms with the entry column_hops, initialized to 0, in the right direction. On reception of a column-message ms from the left direction and ms.column_hops<column_counter, the message is rejected. If ms.column_hops>=column_counter the value of ms.column_hops is incremented with one and the value of column counter is set equal to MAX(ms.column_hops, column_counter). The message with the incremented value is sent on in the up, right and down direction. On reception of a column-message, ms, from the up (down) direction, the value of ms.column_hops is compared with the value of column_counter. When ms.column_hops>column_counter, column_counter is set equal to ms.column_hops, and the message is sent on in the up and down direction, and in the right direction with an incremented ms.column_hops. When neighboring faulty nodes are present in a row or a column, the algorithm works perfectly (provided that there is no network separation). Due to the parallelism in the algorithm, the total commissioning time is determined by passing a message over all rows followed by a message over all columns. The redundancy of messages in the algorithm dies out quickly, because the test on counters will enforce rejection of messages for most redundancy messages. With little message loss it may be sufficient to run the algorithm twice in order to perform a complete commissioning of the grid.

Detecting Neighbored Nodes:

During routing of a message, it may be interesting to signify whether there is a neighbor at any of the four directions. The following algorithm is proposed to perform this: Each direction may have a connection variable {UP, DOWN, RIGHT, LEFT} with three values: connected, unknown, disconnected. All connection variables are originally set to connected. At regular intervals the node sends a “present?”-message in a given direction and sets connection to unknown when the value is connected and disconnected otherwise. A node which receives a “present?”-message returns a “present!”-message. When a node receives a “present!”-message, it sets the corresponding connection variable to connected. Consequently, when a direction has a connection variable with value disconnected, the routing need not send any messages in that direction because there is no working neighbor. In order to avoid that neighbors which are one hop away may answer the “present?”-message, the “present!”-message may contain the source address of the answering node. Then, the destination node can compare the address and reject the unwanted ones. This assumes that the commissioning has correctly done its job.

Order of Node Switching:

Next, the order of node switching is discussed. Two stages in the switching on of luminaries may be discerned. In the first phase, the luminaries are connected to the mains electricity supply. At this moment the nodes are switched on and the drivers are powered. In the second phase, a DALI command is sent over the network to the node to switch on the light of the luminary. The node switching cannot be done simultaneously because the drivers draw to much current at switching on time. Therefore, two approaches of the order in which nodes are switched on according to the invention are discussed in detail in the following in order to verify whether the commissioning will terminate correctly.

First Inventive Approach: Order of Switching

First, it is supposed that the nodes of a whole row are switched on simultaneously, but the columns are switched on in a given order. The commissioning algorithm according to the invention will work correctly for the whole row, but will stop executing when the column part starts. Without loss of generality the behavior in a row when nodes are switched on in a given order may be considered. Supposing that first the left most node is switched on, followed by its right neighbor, followed by its right neighbor. At node [0, 0] a commissioning message is sent to the right, which does not arrive in [0, 1]. No more commissioning messages are sent from [0, 0] from then onwards. When node [0, 1] switches on, it will receive no commissioning message from [0, 0], and its column number is not increased. The same reasoning holds for all right neighbors, and it may be concluded that all column numbers remain zero.

In order to avoid this the present invention suggests to switch on nodes from right to left. When node [0, k] is switched on, nodes [0, k+1] to [0, n] are all switched on. The message from node [0, k] will percolate through the row and increase the column numbers. Once node [0, 0] is switched on the row algorithm has run to its conclusion and all nodes in this row have the right column number as long as no nodes are faulty. The same can be done with the order of switching on rows which are switched on from the row with the highest number first. While a row is switching on, the messages with the lower column numbers, generated by the last switched on node, will be rejected by the up and down neighbors, because the column numbers in the message are lower than the column number in the node.

Second Inventive Approach: Connection Check and Node Reset

According to this second approach, a node sends a “node-up” message over its down and left channel. When a node receives a node-up message over its right channel it sends a column-message over its right channel. When a node receives a “node-up” message over its up channel it sends a row-message over the up-channel. It easily follows that when the left lowest node switches on, the column and row counter of all directly connected nodes have the correct value. The case that not the direct neighbor answers but the one hop away neighbor responds, is considered in the following. It is assumed that a complete row is switched off. In that case, the network will behave as if the switched off row does not exist. Then, it is considered that only a subset of the nodes in the row is switched off. This is exactly the case considered for algorithm 3. Consequently all connected nodes will use the highest row and column number they receive.

Next, an implementation of a message routing algorithm according to the invention is explained in detail.

Due to the simple addressing in columns and row, routing without failing nodes may be quite straightforward. An embodiment of the routing protocol according to the invention may compare first the column numbers of the node with the column number of the destination. When the node's column is smaller (larger) than the destination' column, the messages is routed to the right (left). When the columns are equal and the node's row number is smaller (larger) than the destination's row number, the message is routed up (down).

When there are faulty nodes, routing becomes more complex. Below two embodiments of algorithms according to the invention are given: (1) executed when a sender starts sending, and (2) when a receiver receives a message. A (commissioning) message, ms, is given four Booleans to indicate that it moves in a given direction after meeting an obstacle.

```
ML: obstacle met in left channel
MR: obstacle met in right channel
MU: obstacle met in up channel
MD: obstacle met in down channel
A message, ms, has five attributes
ms.row_src, and ms.column_src represent source address.
ms.row_dst, and ms.column_dst represent destination address.
ms.htl represents the hops to live
At the sender the packets are sent on their way.
Set {MD, MU, MR, ML} to FALSE in ms.
Initiate ms.htl equal to 3*abs(row_counter − ms.row_dst) +
3*abs(column_counter − ms.column_dst).
  IF row_counter < ms.row_dst and UP = connected THEN send packet up
  Elsif row_counter > ms.row_dst and DOWN = connected THEN send packet
down
  Elsif column_counter > ms.column_dst and LEFT = connected THEN send
packet left
  Elsif column_counter < ms.column_dst and RIGHT = connected THEN send
packet right
  Elsif column_counter<> ms.column_dst THEN{
  IF column_counter < ms.column_dst THEN ms.MR := TRUE
  ELSE ms.ML := TRUE
  IF UP = connected THEN send packet up
  Elsif DOWN = connected THEN send packet down}
  Elsif ms.row_dst <> row_counter THEN {
  IF row_counter < ms.row_dst THEN ms.MU := TRUE
  ELSE ms.MD := TRUE
  IF RIGHT = connected THEN send packet right
  Elsif LEFT = connected THEN send packet left}
  A received packet has arrived at destination or must be routed on.
  At the reception of a packet ms.htl is decremented with one. It has arrived at
destination when ms.row_dst = row_counter and ms.column_dst = column_counter. When the
condition is false and ms.htl > 0, the packet is routed on.
  Routing on of packet
  When MD, MR, ML and MU are FALSE, the sender algorithm is used.
  In the other case the sending depends on the receiving channel.
  %% First test if obstacle has gone.
  IF ms.MD and DOWN = connected THEN ms.MD := FALSE; send packet
down
  Elsif ms.MU and UP = connected THEN ms.MU := FALSE; send packet up
  Elsif ms.MR and RIGHT = connected THEN ms.MR := FALSE; send packet
right
  Elsif ms.ML and LEFT = connected THEN ms.ML : FALSE; send packet left
  %% obstacle is still present
  Elsif reception is right{
  IF LEFT = connected THEN send packet left ELSE send packet right}
  Elsif reception is left{
  IF RIGHT = connected THEN send packet right ELSE send packet left}
  Elsif reception is up{
  IF DOWN = connected THEN send packet down ELSE send packet up}
  Elsif reception is down{
  IF UP = connected THEN send packet up ELSE send packet down}
  ELSE reject message.
```

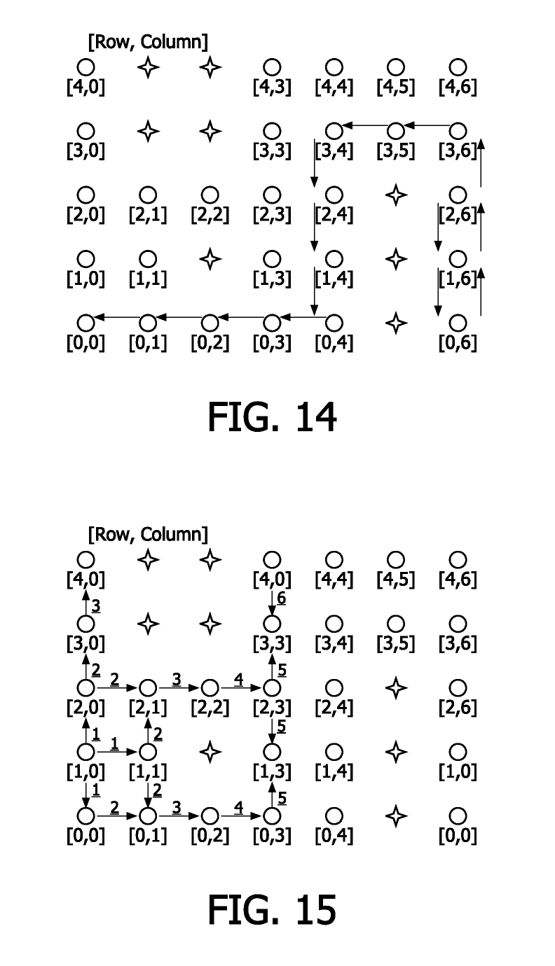

In FIG. 14 the route from node [2, 6] to node [0, 0] is shown. At the beginning row_counter is smaller than ms.row_dst, and the packet is routed down. At node [0, 6] LEFT is not connected, and ms.ML is set to TRUE. Only UP is connected and the packet is routed up. Arriving in node [3, 6], LEFT is connected, and ms.ML is set to FALSE. At node [3, 4] DOWN is connected and the packet is routed down until node [0, 4]. From [0, 4] it is routed left.

Next, an implementation of a multicast message routing algorithm according to the invention is explained in detail.

Lights will be switched on and off in a column or row pattern. It may be probable that the same command is sent to a whole row or column of nodes. The basic idea is that a message will be replicated in the direction to the destination row (column) and perpendicular to that direction, such that the message reaches all nodes in the column (row) as quickly as possible. For efficiency reasons it is necessary to maintain a list of already received messages in each node. Once an arriving message was received earlier, it will not be sent on by a receiving node. A unique identifier is stored in the message containing the origin row and column number and the number of the multicast message sent from the originator.

The algorithm works as follows. Assume a message is sent to an entire column. The treatment of a row is equivalent. The originator sends a message in the direction of the column and parallel to the column in both directions. A receiver checks whether this broadcast was received earlier. If not, for a message coming from the neighbor in the same row, the message is sent in both directions in parallel to the column. If destination column number is different from the receiving node column, the message is sent along the row. An example is shown in FIG. 15. The arrows represent the sending of a broadcast message and the number next to the arrow represents the hop count of the message. Node [1, 0] sends a multicast to column 3 (i.e. all nodes [x, 3]). The message over the first hop is sent to nodes [0, 0], [2, 0] and [1, 1]. After the second hop [2, 1] and [0, 1] are reached. Although a message arrives multiple times, it is sent on only once. The message sent along column 0 is lost finally. After four hops the nodes [2, 3] and [0, 3] are reached. Consequently all nodes in column 3 are reached within 6 hops.

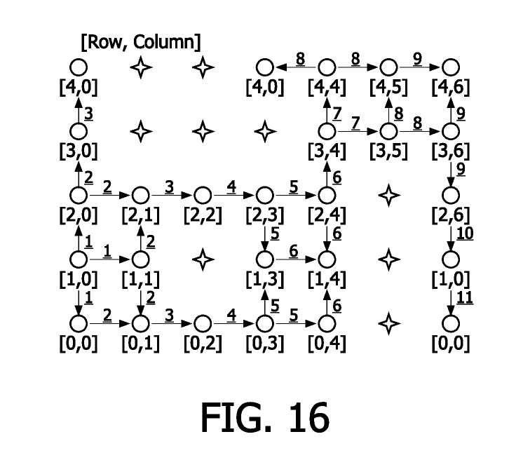

Suppose that node [3, 3] is faulty as shown in FIG. 16. With this algorithm node [4, 3] would not be reached, although node [4, 3] is connected to the network. Even worse supposing the originator is inside column 3 and one node in column 3 is faulty. Again, only one part of the column would receive the multicast. To be robust a broadcast is wanted to reach all connected nodes including the destination row or column. For the broadcast each message is uniquely identified with source address, and broadcast number at source. At reception of a broadcast message the identifier is compared to the already present identifiers. When the identifier is present in the node, nothing is done. Otherwise the identifier is stored and the message is sent on in all three directions but the channel over which the message arrived. The originator sends the message into all four directions. When the destination address in the message corresponds with the node address, the message is passed on to the application. The behavior is shown in FIG. 16, which differs from FIG. 15 with the faulty node [3, 3]. FIG. 16 shows that the broadcast message reaches the connected node [4, 3] after hop 8, in spite of the multiple faulty nodes. The disadvantage is that more messages are sent and more nodes are reached with the broadcast messages.

The invention can be applied in any networked control system such as a complex lighting system with a plurality of light sources, for example a lighting system installed in homes, shops and office applications. The invention is particularly applicable for auto commissioning/configuration of professional environments where light sources are placed in an approximately rectangular grid. Examples of such environments are green houses, factory buildings, sport halls, office buildings and outdoor (matrix) light displays.

At least some of the functionality of the invention may be performed by hard- or software. In case of an implementation in software, a single or multiple standard microprocessors or microcontrollers may be used to process a single or multiple algorithms implementing the invention.

It should be noted that the word “comprise” does not exclude other elements or steps, and that the word “a” or “an” does not exclude a plurality. Furthermore, any reference signs in the claims shall not be construed as limiting the scope of the invention.

1. A method for automatically commissioning of devices of a networked control system, which comprises several devices arranged in a grid wherein each device is configured for routing messages between directly neighbored devices in the grid via light, method comprising
transmitting a commissioning message, which comprises a hops counter, by a first device to a second device, which is neighbored to the first device in a predetermined direction in the grid,
receiving the commissioning message from the first device by the second device,
updating the hops counter by the second device and a location counter of the second device and
transmitting the commissioning message with the updated hops counter to one or more third devices.

2. The method of claim 1, wherein
the act of updating of the hops counter by the second device comprises incrementing the hops counter by one and
the act of updating the location counter of the second device comprises setting the location counter to the maximum of the updated hops counter and the actual location counter.

3. The method of claim 2, wherein the act of updating of the hops counter by the second device further comprises
comparing the hops counter of the received commissioning message with the actual location counter of the second device and
incrementing the hops counter by one only the comparison results in that the hops counter is larger than or equal to the actual location counter of the second device.

4. The method of claim 3, wherein the act of updating of the hops counter by the second device further comprises rejecting the received commissioning message if the comparison results in that the hops counter is smaller than the actual location counter of the second device.

5. The method of claim 1, wherein the transmitting the commissioning message with the updated hops counter to one or more third devices comprises transmitting the commissioning message with the updated hops counter to
a third device, which is neighbored to the second device in the predetermined direction in the grid, or to
third devices, which are neighbored to the second device in the predetermined direction in the grid and in two further different directions, each being different from the predetermined direction.

6. The method of claim 5, wherein a third device, which is neighbored to the second device in a direction different from the predetermined direction, transmits a commissioning message in the predetermined direction in the grid.

7. The method of claim 5, wherein a third device, which is neighbored to the second device in a direction different from the predetermined direction, transmits a commissioning message in the predetermined direction in the grid and in the two further different directions, each being different from the predetermined direction.

8. The method of claim 1, wherein several commissioning message are routed in parallel through the grid in one or more predetermined directions.

9-11. (canceled)

12. A system for automatically commissioning of devices of a networked control system, which comprises several devices arranged in a grid, wherein each device is adapted for routing messages, which were received from directly neighbored devices in the grid, to directly neighbored devices in the grid via light, wherein the system is configured to commission the devices by performing the acts of
transmitting a commissioning message, which comprises a hops counter, by a first device to a second device, which is neighbored to the first device in a predetermined direction in the grid,
receiving the commissioning message from the first device by the second device,
updating the hops counter by the second device and a location counter of the second device and
transmitting the commissioning message with the updated hops counter to one or more third devices.

13. (canceled)

14. A device being adapted for application in a system of claim 12, particularly a luminary, and being further adapted to communicate directional light messages.

15. The device of claim 14, comprising at least one of the following features:
the device is a luminary and being adapted in that the light of the main light source of the luminary is used for communication by means of directional light messages;
the device comprises collimators and/or lenses being applied to a light source used for communicating directional light messages and/or to a light sensor used for receiving directional light messages from other devices;
the directional light messages are invisible to the human eye;
the devices is adapted to communicate directional light messages in four different directions;
the devices is adapted to communicate directional light messages in four different directions, wherein the different directions are separated by an angle of 90° degree.
